(19) United States
(12) Patent Application Publication
(10) Pub. No.: US 2018/0309576 A1
(43) Pub. Date: Oct. 25, 2018

(54) BRIDGING BETWEEN A FINGERPRINT SENSOR AND A HOST

(71) Applicant: Image Match Design Inc., Zhubei City (TW)

(72) Inventor: Sun-How JIANG, Hsinchu City (TW)

(21) Appl. No.: 15/956,144

(22) Filed: Apr. 18, 2018

(30) Foreign Application Priority Data
Apr. 19, 2017 (TW) 106113094

(51) Int. Cl. H04L 9/32; H04L 9/06

(52) U.S. Cl. CPC H04L 9/3231; H04L 9/3228; H04L 9/0631

(57) ABSTRACT

A fingerprint-encrypting method is used between a fingerprint sensor and a host to perform encryption on a fingerprint datum with a universal encryption standard. The encryption standard of universal specifications is designed to be a physical circuit that is placed in a bridge integrated circuit, so that the encryption process can in terms of duration meet the timeframe provided by the system for fingerprint data transmission and processing.

### CROSS-REFERENCE TO RELATED APPLICATIONS

This application claims the priority benefit of Taiwan Application No. 106113094, filed 19 Apr. 2017, the contents of which in its entirety are herein incorporated by reference.

### FIELD OF THE INVENTION

Every human fingerprint has unique features, making it a proof of identification. FIG. 1 depicts a conventional fingerprint identification system, which comprises a fingerprint sensor 10 and a host 16. The fingerprint sensor 10 includes a sensing unit 12 for detecting a fingerprint of a finger, and sending a fingerprint datum obtained from the foregoing detection to the host 16 via an interface 14. The host 16 compares the fingerprint datum it receives to fingerprint data in a database so as to identify a user. For protecting the fingerprint datum transmitted through the interface 14 from unauthorized access, the fingerprint sensor 10 performs basic encryption on it before sending it to the host 16 through the interface 14. There are many ways for basic encryption, such as the scramble encryption disclosed in China Patent Publication No. CN106548122A.

With the increase of security requirements, more and more fingerprint encryption systems try to encrypt fingerprint data using encryption standards that have universal specifications, such as the Advanced Encryption Standard (AES). However, in order to perform encryption using encryption standards that have universal specifications with the foregoing fingerprint sensor 10, addition of huge memory circuits and complicated encryption algorithm circuits is necessary. This leads to expanded chip areas and significantly increased costs. Furthermore, due to process limits, the fingerprint sensor 10 is unable to provide high-frequency clock that is required to process encryption with complicated encryption standards. Thus, even if the fingerprint sensor 10 is made with circuits of universal encryption standards, the process of encryption will be so slow that the transmission of fingerprint data to the host 16 is too slow to meet the timeframe provided by the system for fingerprint data transmission and processing. Hence, there has not been a fingerprint sensor 10 or other encryption systems adopting universal encryption standards successfully.

### SUMMARY OF THE INVENTION

According to the present invention, a circuit and method for detecting and encrypting fingerprints involve having a fingerprint sensor detect a fingerprint of a finger. The method further comprises having a bridge integrated circuit between the fingerprint sensor and the host perform encryption on the fingerprint datum with an encryption standard.

Particularly, the bridge integrated circuit comprises an encryption standard circuit for encrypting the fingerprint datum with the encryption standard.

Since the present invention makes the encryption standard a physical circuit that is placed in the bridge integrated circuit, the encryption process can in terms of duration meet the timeframe provided by the system for fingerprint data transmission and processing.

### BRIEF DESCRIPTION OF THE DRAWINGS

FIG. 1 depicts a conventional fingerprint identification system;

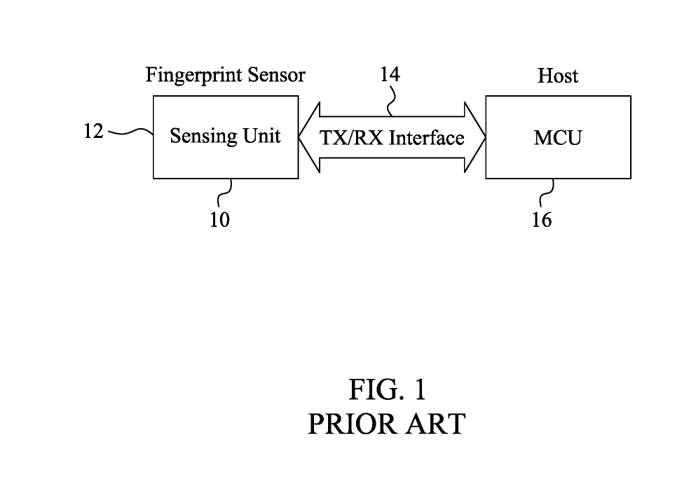

FIG. 2 shows a first embodiment of a fingerprint-detecting-and-encrypting circuit according to the present invention;

FIG. 3 shows a first embodiment of the operational process used by the circuit shown in FIG. 2;

FIG. 4 illustrates the principle of multiple basic encryption;

FIG. 5 shows a second embodiment of a fingerprint-detecting-and-encrypting circuit according to the present invention;

FIG. 6 shows a third embodiment of a fingerprint-detecting-and-encrypting circuit according to the present invention;

FIG. 7 shows a first embodiment of the operational process used by the circuit shown in FIG. 6;

FIG. 8 shows a second embodiment of the operational process used by the circuit shown in FIG. 6;

FIG. 9 shows a fourth embodiment of a fingerprint-detecting-and-encrypting circuit according to the present invention;

FIG. 10 shows an embodiment of the operational process used by the circuit shown in FIG. 9;

FIG. 11 shows a fifth embodiment of a fingerprint-detecting-and-encrypting circuit according to the present invention;

FIG. 12 shows an embodiment of the operational process used by the circuit shown in FIG. 11;

FIG. 13 shows a sixth embodiment of a fingerprint-detecting-and-encrypting circuit according to the present invention;

FIG. 14 shows an embodiment of the operational process used by the circuit shown in FIG. 13;

FIG. 15 shows a seventh embodiment of a fingerprint-detecting-and-encrypting circuit according to the present invention; and

FIG. 16 shows an embodiment of the operational process used by the circuit shown in FIG. 15.

### DETAILED DESCRIPTION OF THE INVENTION

The present invention makes an encryption standard of universal specifications a physical circuit that is placed in a chip made of an advanced process, and bridges the chip between a fingerprint sensor and a host, so as to perform standard encryption on fingerprint data. In other words, memory circuits and encryption algorithm circuits required by the standard encryption are integrated in the bridge integrated circuit. Since the bridge integrated circuit is made using the advanced process for miniaturization, the chip is small in area and able to provide high-frequency clock for speeding up encryption, making the encryption process meet the timeframe provided by the system for fingerprint data transmission and processing. The bridge integrated circuit of the present invention is suitable for various fingerprint sensors, such as capacitive, photoelectric, glass-sensing fingerprint sensors. In addition, the bridge integrated circuit of the present invention may be used together with fingerprint sensors from different manufacturers. For a system builder who wants to add the encryption standard in the existing fingerprint encryption system, the bridge integrated circuit of the present invention is convenient to use because the purpose can be easily achieved by adding the disclosed bridge integrated circuit between the fingerprint sensor and the host instead of replacing the whole fingerprint encryption system.

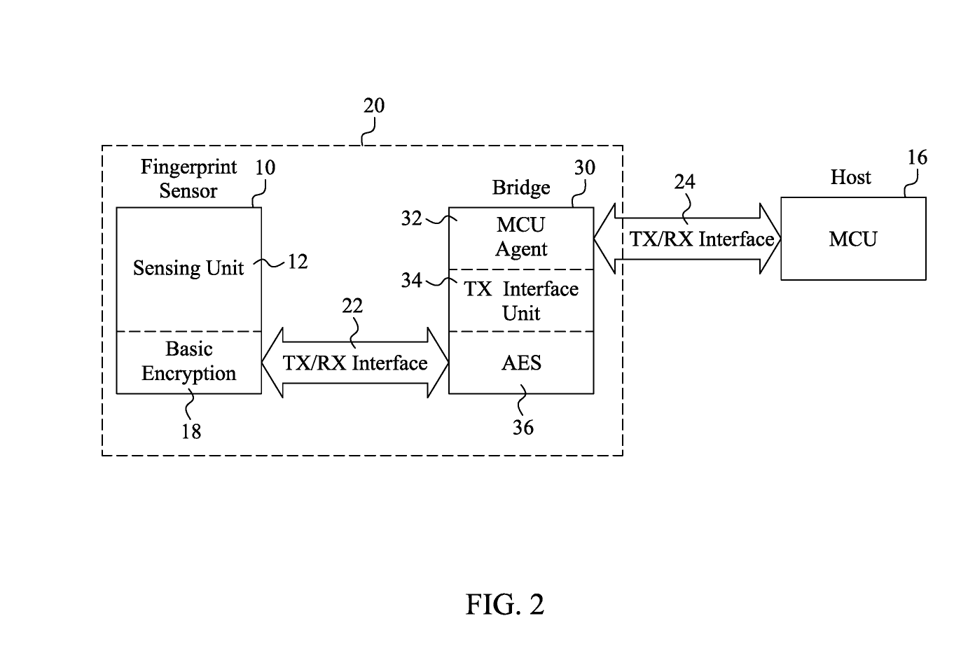

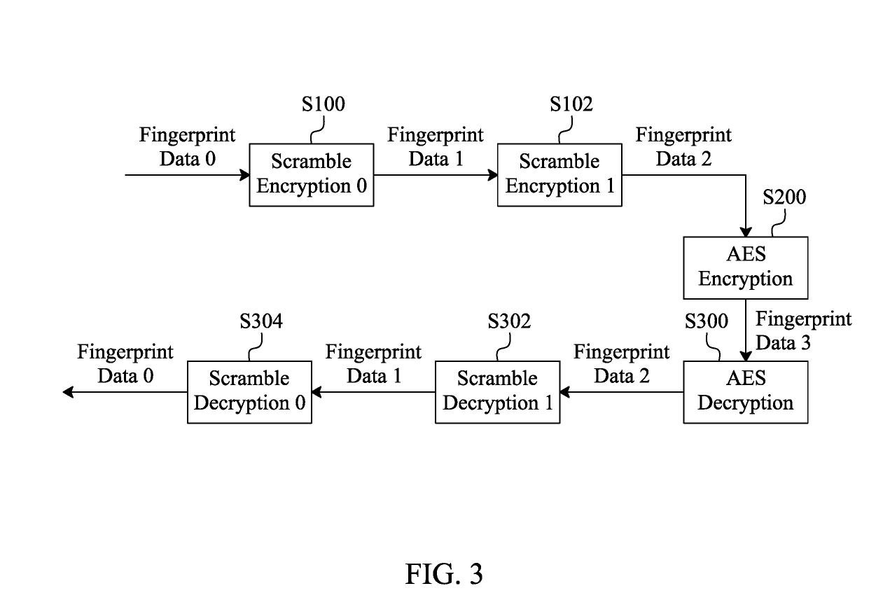

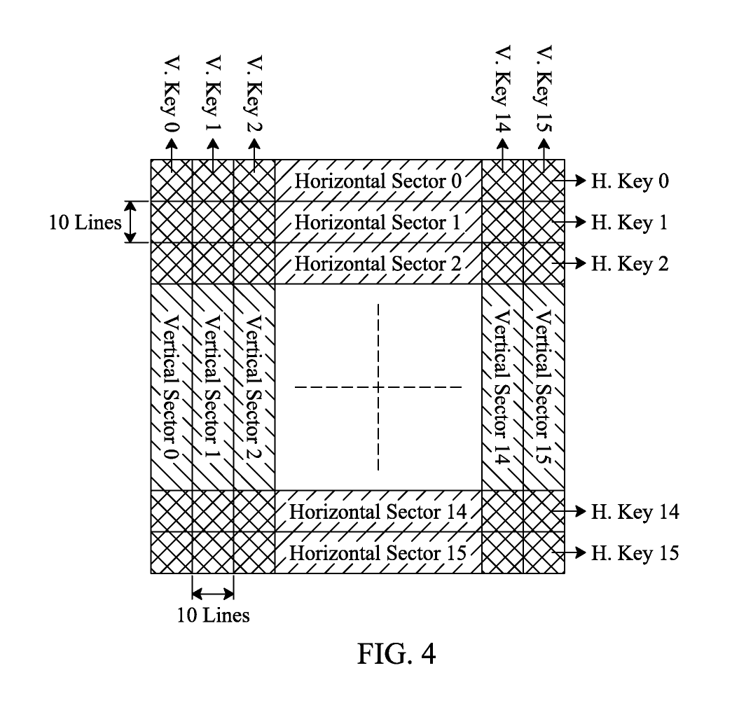

FIG. 2 shows a first embodiment of a fingerprint-detecting-and-encrypting circuit of the present invention. FIG. 3 shows an embodiment of an operational process of the circuit of FIG. 2. In the fingerprint encryption system of FIG. 2, there are a fingerprint-detecting-and-encrypting circuit 20 and a host 16. The fingerprint-detecting-and-encrypting circuit 20 comprises a fingerprint sensor 10 and a bridge integrated circuit 30 bridging between the fingerprint sensor 10 and the host 16. The fingerprint sensor 10 comprises a sensing unit 12 and a basic encryption circuit 18. The bridge integrated circuit 30 comprises a host agent 32, an interface unit 34 and an AES circuit 36. The sensing unit 12 detects a fingerprint of a finger to generate a fingerprint datum 0. The basic encryption circuit 18 performs basic encryption on the fingerprint datum 0 to protect the fingerprint datum from unauthorized access during its transmission to the bridge integrated circuit. The basic encryption may be achieved by various means. In the present embodiment, the basic encryption circuit 18 performs encryption using scramble encryption. In the embodiment of FIG. 3, the basic encryption circuit 18 performs a first time of scramble encryption on the fingerprint datum 0 to generate fingerprint datum 1, as shown in step S100. Then the basic encryption circuit 18 performs a second time of scramble encryption on the fingerprint datum 1 to generate a fingerprint datum 2, as shown in step S102. In other embodiments, the basic encryption circuit 18 may alternatively perform a single time of encryption or perform more than two times of encryption. FIG. 4 illustrates how to perform multiple basic encryption. Assuming that the fingerprint datum is a 160×160 array, when the first scramble encryption is performed in step S100, scramble encryption is performed on horizontal sections 0 through 15 of the fingerprint datum 0 to generate the fingerprint datum 1, and when the second scramble encryption is performed in step S102, scramble encryption is performed on vertical sections 0 through 15 of the fingerprint datum 1 to generate the fingerprint datum 2. The encrypted sections may have the same or different decryption keys H.Key0˜H.Key15 and V.Key0˜V.Key15. Furthermore, in the embodiment of FIG. 3, steps S100 and S102 use the same way of basic encryption (scramble encryption) to perform encryption. However, in other embodiments, steps S100 and S102 may use different ways of basic encryption to perform encryption.

Upon completion of the basic encryption, the fingerprint sensor 10 sends the fingerprint datum 2 to the bridge integrated circuit 30 via the interface 22. The AES circuit 36 of the bridge integrated circuit 30 receives the fingerprint datum 2 and performs AES encryption on it to generate a fingerprint datum 3, as shown in step S200 of FIG. 3. While in the embodiment of FIG. 2 and FIG. 3 the AES (Advanced Encryption Standard) is used for encryption, in other applications, other encryption standards may be used for the same purpose. Upon completion of the AES encryption, the bridge integrated circuit 30 sends the fingerprint datum 3 to the host 16 via the interface 24. The host agent 32 of the bridge integrated circuit 30 is connected to the AES circuit 36 and the host 16 through the interface unit 34. The interface unit 34 may be a USB interface or a serial peripheral interface (SPI). The host agent 32 receives command from the host 16 and operates the fingerprint sensor 10 and the AES circuit accordingly.

After receiving the fingerprint datum 3, the host 16 performs step S300 to perform AES decryption on the fingerprint datum 3 to obtain the fingerprint datum 2. Then it performs step S302 to decrypt the fingerprint datum 2. step S302 is a decryption procedure corresponding to step S102, so the fingerprint datum 1 is obtained after the decryption. At last, step S304 is performed to perform decryption on the fingerprint datum 1. Since step S304 is a decryption procedure corresponding to step S100, the fingerprint datum 0 is obtained after the decryption. After the fingerprint datum 0 is obtained, the host 16 compares it with fingerprint data in a database to determine whether the fingerprint datum 0 is correct. Preferably, for preventing the decryption key from unauthorized access during transmission, the decryption key may be stored in the host 16 in advance, instead of being transmitted through the interfaces 22 and 24.

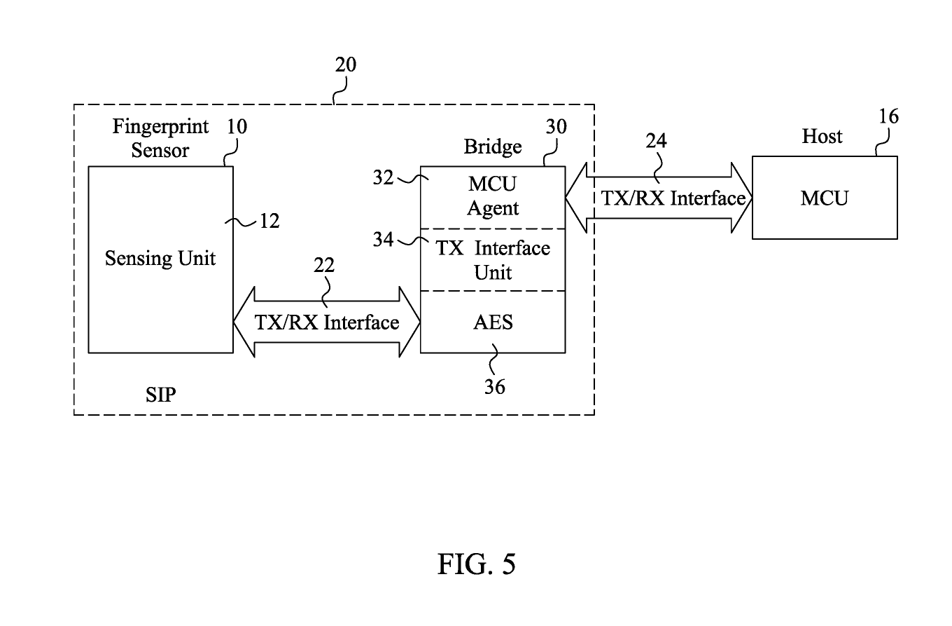

In the circuit of FIG. 2, the fingerprint sensor 10 and the bridge integrated circuit 30 may be integrated in a system in package (SIP). In this case, the sensing unit 12 can transmit the generated fingerprint datum 0 to the bridge integrated circuit 30 directly without encryption, so the basic encryption circuit 18 can be omitted. FIG. 5 is a second embodiment of the fingerprint-detecting-and-encrypting circuit 20 according to the present invention. The fingerprint sensor 10 and the bridge integrated circuit 30 are integrated in an SIP. The circuit of FIG. 5 is similar to its counterpart shown in FIG. 2 except that the fingerprint sensor 10 of FIG. 5 is built without the basic encryption circuit 18. After the sensing unit 12 detects the fingerprint of the finger and generates the fingerprint datum 0, the fingerprint sensor 10 sends the fingerprint datum 0 directly to the bridge circuit 30 for AES encryption.

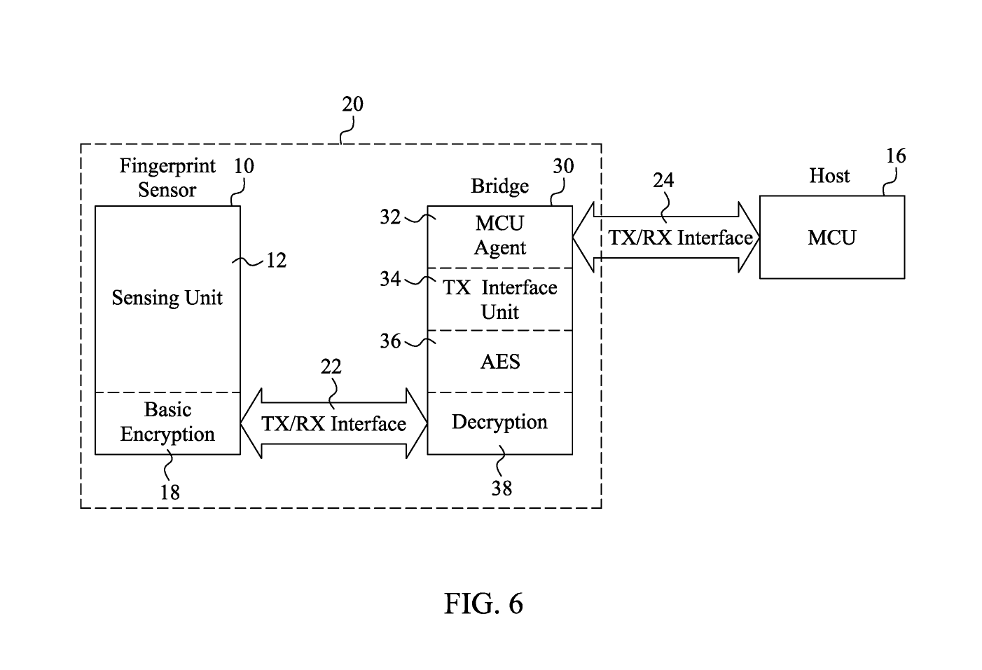

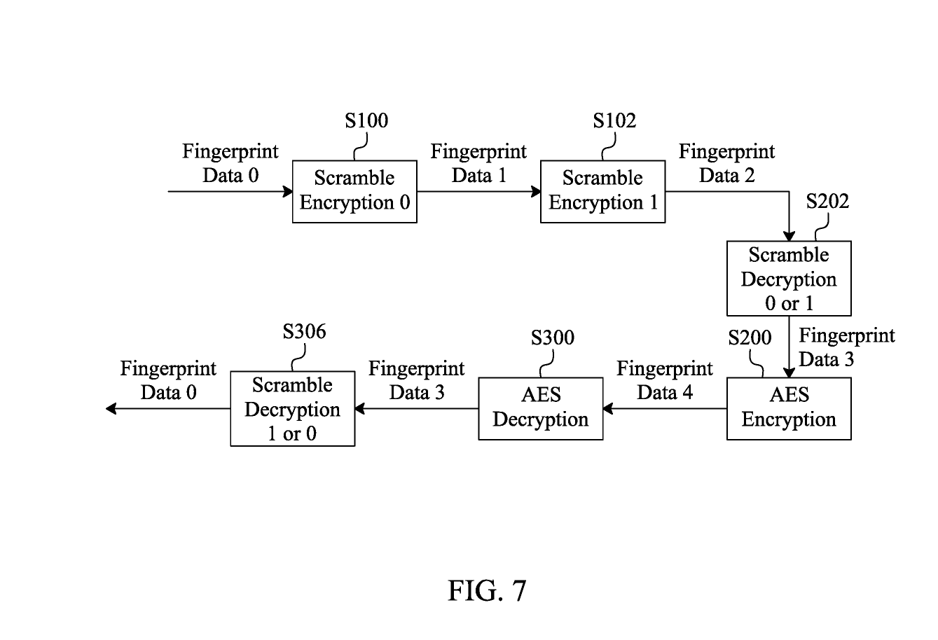

FIG. 6 is a third embodiment of the fingerprint-detecting-and-encrypting circuit 20 according to the present invention. It is similar to its counterpart shown in FIG. 2 except that t the bridge integrated circuit 30 of FIG. 6 further comprises a decryption circuit 38 that serves to perform decryption on the fingerprint datum from the fingerprint sensor 10 and then send the decrypted fingerprint datum to the AES circuit for AES encryption. FIG. 7 is a first embodiment of the operational process of the circuit of FIG. 6. The process shown in FIG. 7, like its counterpart in FIG. 3, has steps S100 and S102. The fingerprint datum 0 generated by the sensing unit 12 receives scramble encryption in steps S100 and 102 and becomes the fingerprint datum 2. The decryption circuit 38 of the bridge integrated circuit 30 receives and performs partial decryption circuit 38 on the fingerprint datum 2. As shown in step S202, the decryption circuit 38 performing decryption against the scramble encryption of step S100 or S102 to generate fingerprint datum 3. Then the AES circuit 36 performs AES encryption on the fingerprint datum 3 to generate a fingerprint datum 4, as shown in step S200. The bridge integrated circuit 30 sends the fingerprint datum 4 to the host 16 via the interface 24. As shown in step S300, the host 16 performs AES decryption on the fingerprint datum 4 it receives to obtain the fingerprint datum 3, and step S306 is performed to perform decryption against the scramble encryption of step S102 or S100 to obtain the fingerprint datum 0 for fingerprint comparison. Particularly, where step S202 is about decryption against step S100, step S306 is about decryption against step S102. On the contrary, if step S202 is about decryption against step S102, step S306 is about decryption against step S100. Preferably, the decryption key may be stored in the bridge integrated circuit 30 and the host 16 in advance, but not transmitted through the interfaces 22 and 24.

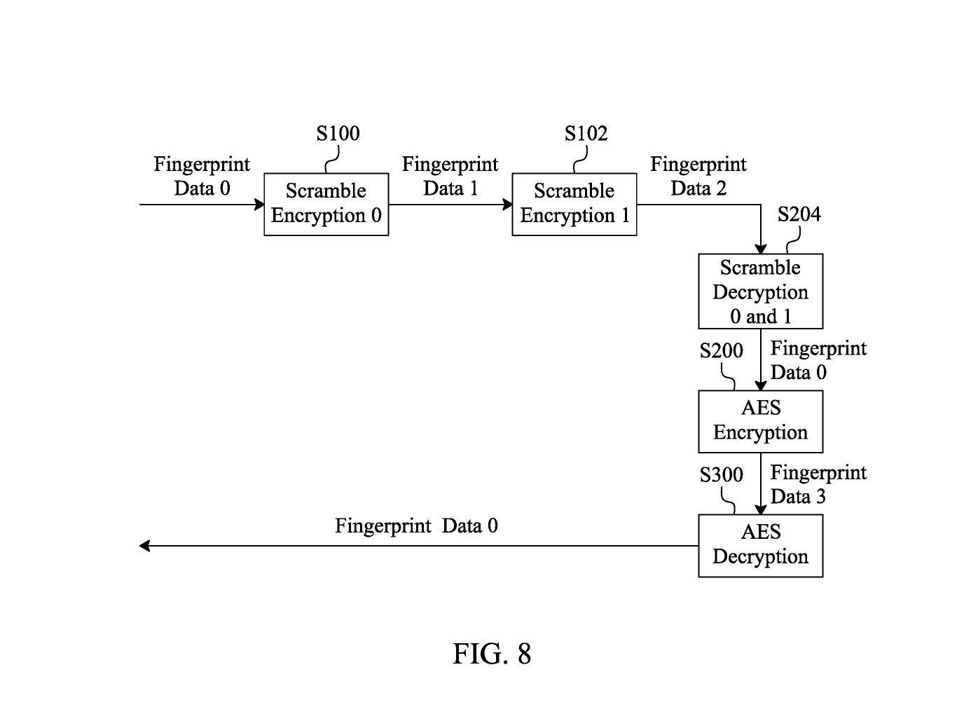

FIG. 8 is a second embodiment of the operational process of the circuit of FIG. 6. The process of FIG. 8, like its counterpart in FIG. 3, comprises steps S100 and S102. The fingerprint datum 0 generated by the sensing unit 12 receives scramble encryption of steps S100 and 102 and becomes the fingerprint datum 2. The decryption circuit 38 of the bridge integrated circuit 30 receives and performs full decryption on the fingerprint datum 2. As shown in step S204, the decryption circuit 38 performs decryption against the scramble encryption of steps S100 and S102 to obtain the fingerprint datum 0. Then the AES circuit 36 performs AES encryption on the fingerprint datum 0 to generate the fingerprint datum 3, as shown in step S200. The bridge integrated circuit 30 sends the fingerprint datum 3 to the host 16 via the interface 24. As shown in step S300, the host 16 performs AES decryption on the fingerprint datum 3 it receives to obtain the fingerprint datum 0. Preferably, the decryption key may be stored in the bridge integrated circuit 30 and the host 16 in advance, but not transmitted through the interfaces 22 and 24.

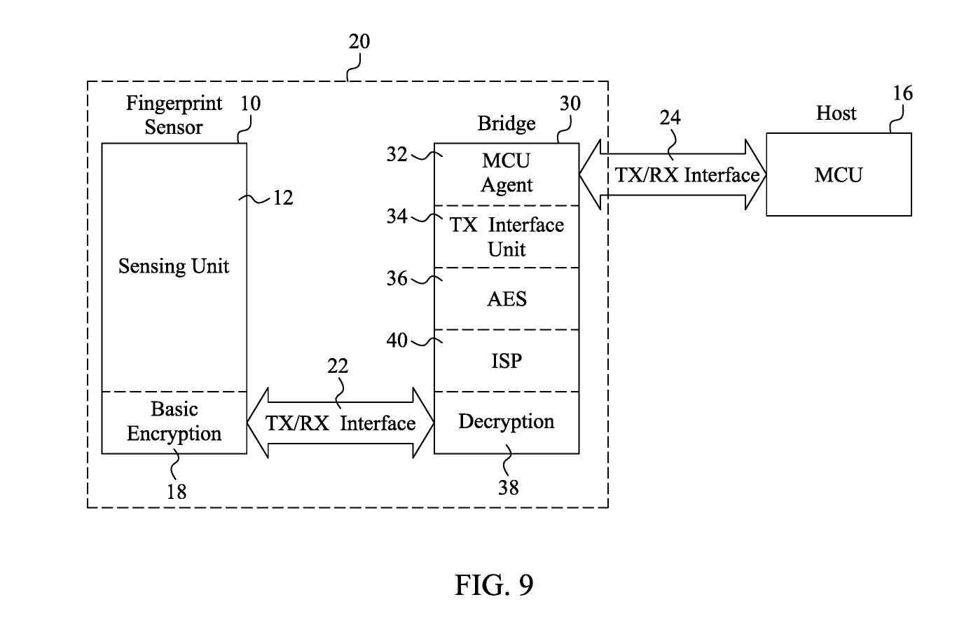

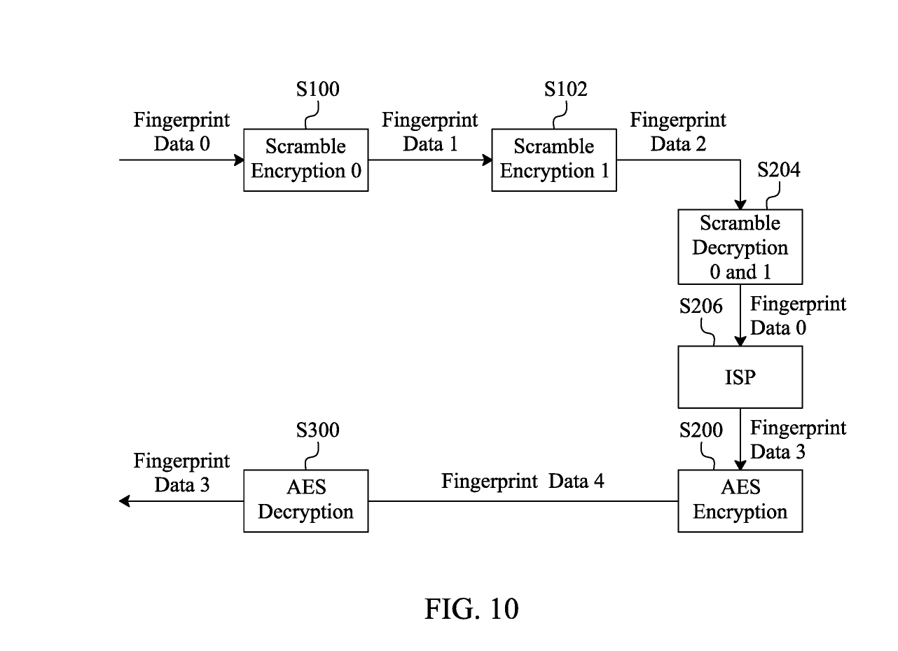

FIG. 9 is a fourth embodiment of the fingerprint-detecting-and-encrypting circuit 20 according to the present invention. It is similar to the circuit of FIG. 6 except that the bridge circuit 30 further comprises an image signal processor (ISP) 40. FIG. 10 shows the operational process of the circuit of FIG. 9. Referring to FIG. 9 and FIG. 10, the sensing unit 12 of the fingerprint sensor 10 detects a fingerprint of a finger and generates a fingerprint datum 0. Then in steps S100 and S102 as shown in FIG. 10, the basic encryption circuit 18 performs two times of scramble encryption on the fingerprint datum 0 to generate a fingerprint datum 2. At last the fingerprint sensor 10 sends the fingerprint datum 2 to the bridge integrated circuit 30 via the interface 22. The bridge integrated circuit 30, after receiving the fingerprint datum 2, has the decryption circuit 38 perform full decryption on the fingerprint datum 2. As shown in step S204, the decryption circuit 38 performs decryption against the scramble encryption of steps S100 and S102 to obtain the fingerprint datum 0. Afterward, as shown in step S206, the ISP 40 of the bridge circuit 30 performs image processing on the fingerprint datum 0 to remove noise for improved fingerprint recognition and enhanced images, thereby generating a fingerprint datum 3. At last, the AES circuit 36 of the bridge integrated circuit 30 performs AES encryption on the fingerprint datum 3 to generate a fingerprint datum 4, as shown in step S200. The host 16 receives the fingerprint datum 4 via the interface 24 and decrypts it to obtain the fingerprint datum 3 for fingerprint comparison, as shown in step S300. Preferably, the decryption key may be stored in the bridge integrated circuit 30 and the host 16 in advance, without transmission through the interfaces 22 and 24. In other embodiments where the fingerprint sensor 10 and the bridge integrated circuit 30 are integrated in an SIP, the encryption circuit 18 of the fingerprint sensor 10 and the decryption circuit 38 of the bridge integrated circuit 30 can be omitted. In this case, steps S100, S102 and S204 can be omitted from FIG. 10.

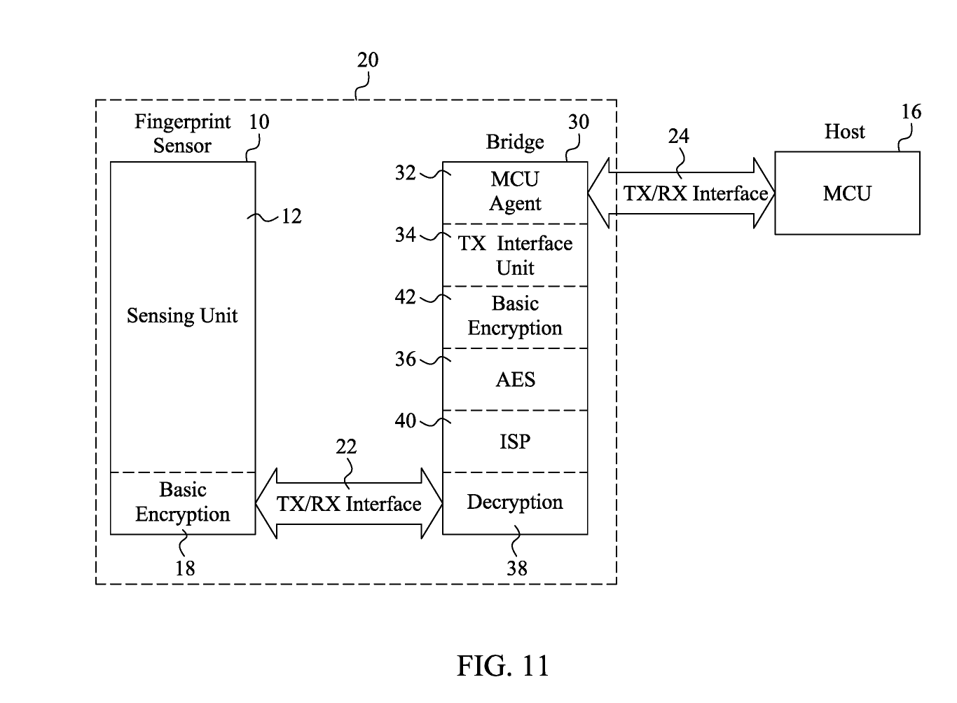

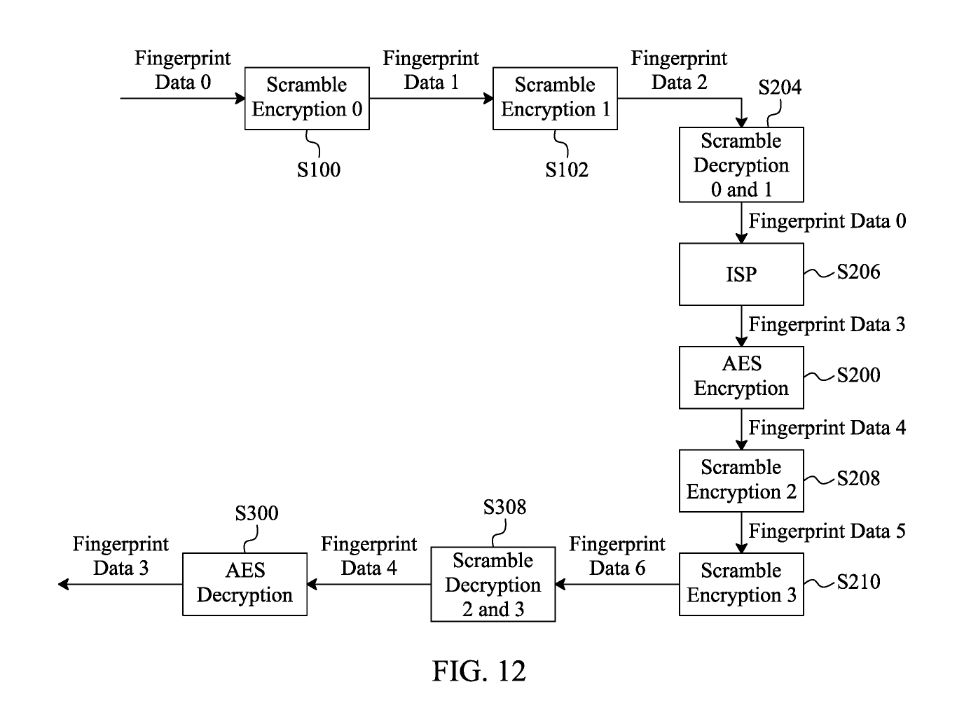

FIG. 11 is a fifth embodiment of the fingerprint-detecting-and-encrypting circuit 20 according to the present invention. It is similar to the circuit of FIG. 9, except that the bridge circuit 30 further comprises a basic encryption circuit 42. FIG. 12 shows the operational process of the circuit of FIG. 11. Referring to FIG. 11 and FIG. 12, the sensing unit 12 of the fingerprint sensor 10 detects a fingerprint of a finger and generates a fingerprint datum 0. Then in steps S100 and S102 as shown in FIG. 12, the basic encryption circuit 18 performs two times of scramble encryption on the fingerprint datum 0 to generate a fingerprint datum 2. At last, the fingerprint sensor 10 sends the fingerprint datum 2 to the bridge integrated circuit 30 via the interface 22. The bridge integrated circuit 30 receives the fingerprint datum 2 and has the decryption circuit 38 perform full decryption on the fingerprint datum 2. As shown in step S204, the decryption circuit 38 performs decryption against the scramble encryption of steps S100 and S102 to obtain the fingerprint datum 0. Then as shown in step S206, the ISP 40 of the bridge integrated circuit 30 performs image processing on the fingerprint datum 0 to remove noise for improved fingerprint recognition and enhanced images, thereby generating the fingerprint datum 3. Then the AES circuit 36 of the bridge integrated circuit 30 performs AES encryption on the fingerprint datum 3 to generate a fingerprint datum 4, as shown in step S200. After the AES encryption, the basic encryption circuit 42 of the bridge integrated circuit 30 performs at least one time of basic encryption on the fingerprint datum 4, as shown in step S208 and S210 of FIG. 12. In step S208, the basic encryption circuit 42 performs scramble encryption on the fingerprint datum 4 to generate a fingerprint datum 5. Then in step S210, the basic encryption circuit 42 performing one more time of scramble encryption on the fingerprint datum 5 to generate a fingerprint datum 6. After receiving the fingerprint datum 6 from the interface 24, the host 16 first performs scramble decryption on it, as shown in step S308. The decryption of step S308 is against the scramble encryption of steps S208 and S210. After the decryption of step S308, a fingerprint datum 4 is obtained. Then the host 16 performs the AES decryption of step S300 on the fingerprint datum 4 to obtain the fingerprint datum 3 for fingerprint comparison. Preferably, the decryption key may be stored in the bridge integrated circuit 30 and the host 16 in advance, without transmission through the interfaces 22 and 24. In other embodiments where the fingerprint sensor 10 and the bridge integrated circuit 30 are integrated in an SIP, the encryption circuit 18 of the fingerprint sensor 10 and the decryption circuit 38 of the bridge integrated circuit 30 can be omitted. In this case, step S100, S102 and S204 can be omitted from FIG. 12. In other embodiments, step S100, S102, S208 and S210 of FIG. 12 may be different ways of basic encryption other than scramble encryption, and step S100, S102, S208 and S210 may use the same way or different ways for basic encryption.

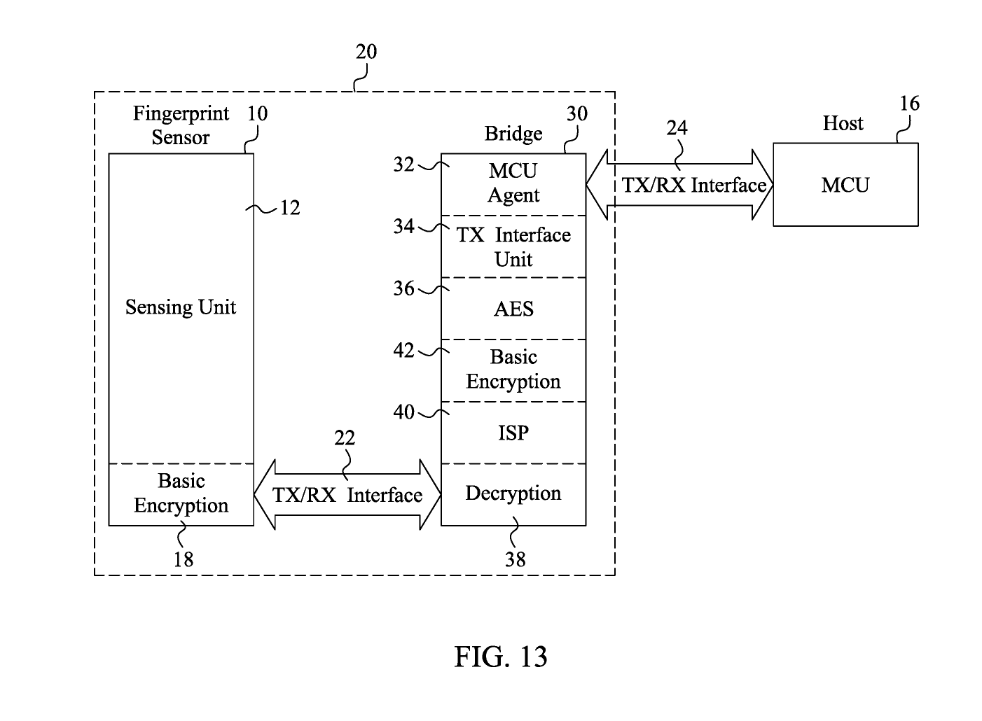

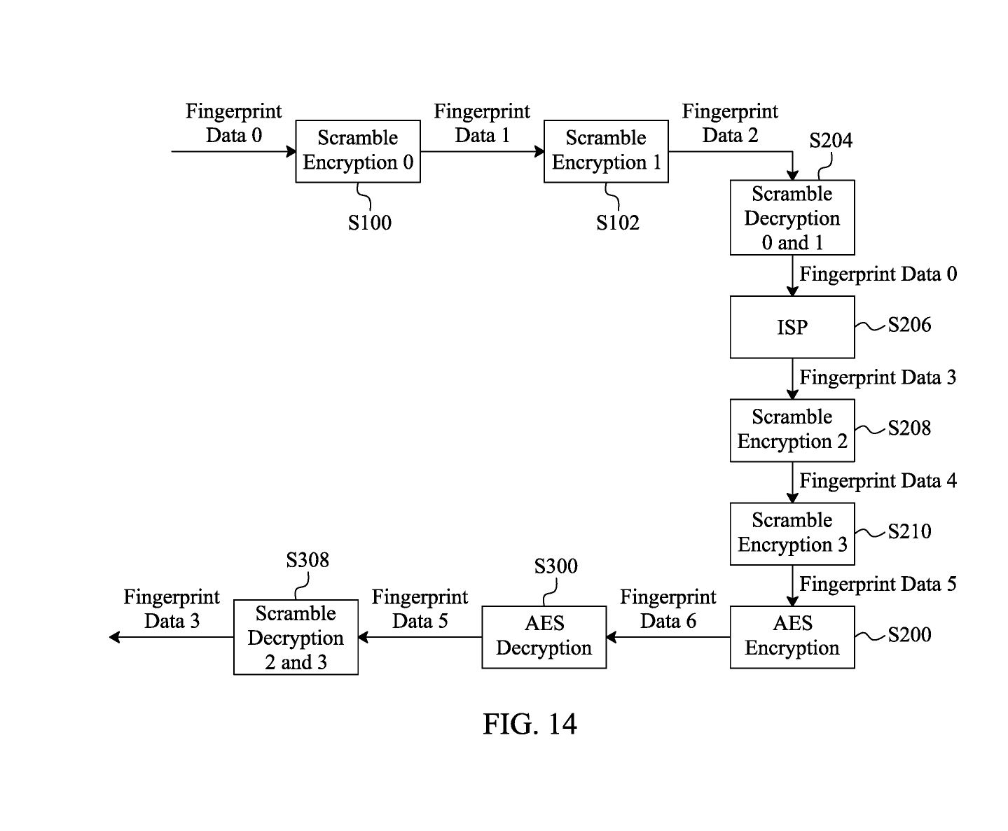

FIG. 13 is a sixth embodiment of the fingerprint-detecting-and-encrypting circuit 20 according to the present invention. It is similar to the circuit of FIG. 11, except that the basic encryption circuit 42 of the bridge circuit 30 is between the AES circuit 36 and the ISP 40. FIG. 14 is the operational process of the circuit of FIG. 13. What shown in FIG. 14 is similar to the process of FIG. 12 except that in step S206 shown in FIG. 14, after image processing, steps S208 and S210 are performed for scramble encryption prior to step S200 where AES encryption is performed. Therefore, in the host 16, step S300 is first performed for AES decryption before step S308 is performed for scramble decryption. Particularly, the processes of FIG. 14 and FIG. 12 perform steps S100, S102, S204 and S206 in the same order, but after step S206, the process of FIG. 14 performs step S208 first. In other words, the bridge integrated circuit 30 has the basic encryption circuit 42 encrypt the fingerprint datum 3 first to generate the fingerprint datum 4, and then in step S210 the basic encryption circuit 42 performs one time of scramble encryption on the fingerprint datum 4 to generate the fingerprint datum 5, before having the AES circuit perform AES encryption on the fingerprint datum 5 in step S200 to generate the fingerprint datum 6. In the process of FIG. 14, after the host 16 receives the fingerprint datum 6 via the interface 24, step S300 is first performed for AES decryption so as to obtain the fingerprint datum 5, and then step S308 is performed for performing scramble decryption on the fingerprint datum to obtain the fingerprint datum 3 for fingerprint comparison.

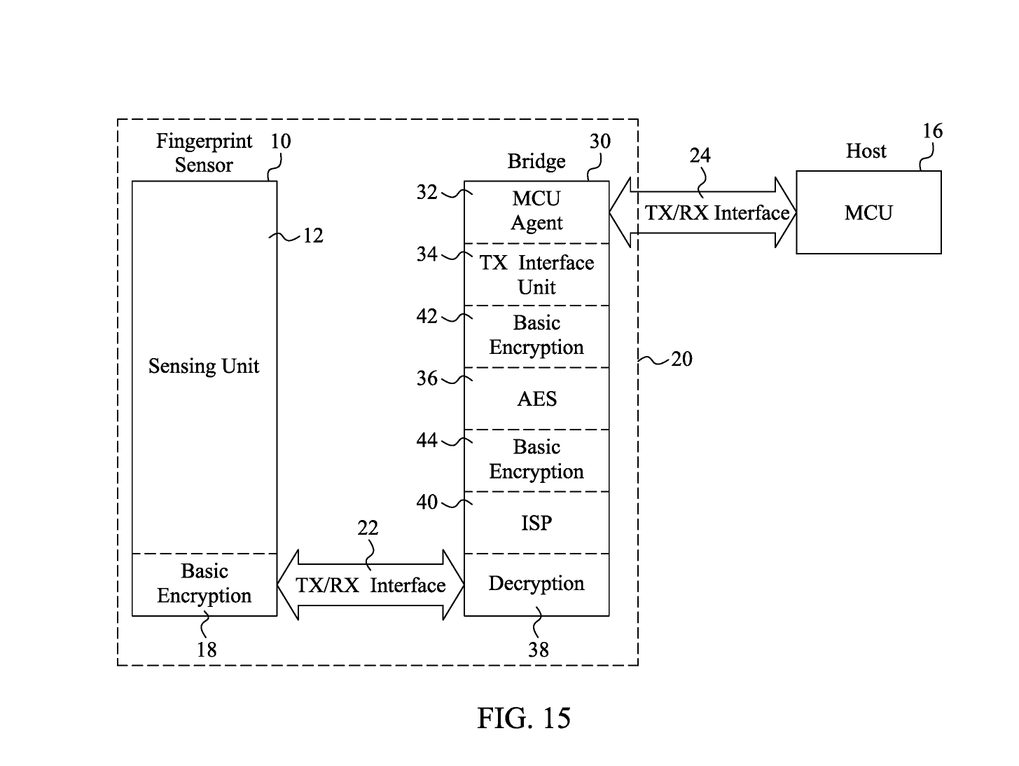

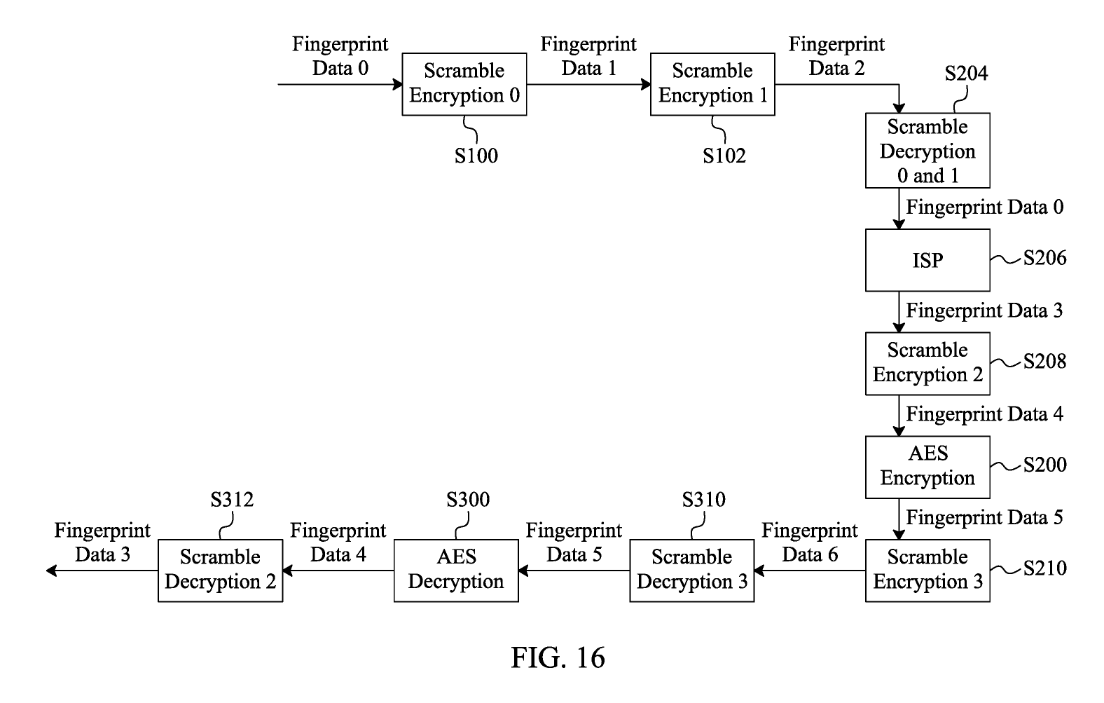

FIG. 15 is a seventh embodiment of the fingerprint-detecting-and-encrypting circuit 20 according to the present invention. It is similar to the circuit of FIG. 11 except that the bridge circuit 30 further comprises a basic encryption circuit 44 between the AES circuit 36 and the ISP 40. FIG. 16 shows the operational process of the circuit of FIG. 15. Referring to FIG. 15 and FIG. 16, the sensing unit 12 of the fingerprint sensor 10 detects a fingerprint of a finger to generate a fingerprint datum 0. Then as shown in steps S100 and S102 of FIG. 16, the basic encryption circuit 18 performs two times of scramble encryption on the fingerprint datum 0 to generate a fingerprint datum 2. Then the fingerprint sensor 10 sends the fingerprint datum 2 to the bridge integrated circuit 30 via the interface 22. After receiving the fingerprint datum 2, the bridge integrated circuit 30 first has the decryption circuit 38 perform full decryption on the fingerprint datum 2. As shown in step S204, the decryption circuit 38 performs decryption against the scramble encryption of steps S100 and S102 to obtain the fingerprint datum 0. Then as shown in step S206, the ISP 40 of the bridge circuit 30 performs image processing on the fingerprint datum 0 to remove noise for improved fingerprint recognition and enhanced image, thereby generating a fingerprint datum 3. After the image processing, the basic encryption circuit 44 of the bridge integrated circuit 30 performs at least one time of basic encryption on the fingerprint datum 3. In the embodiment of FIG. 16, the basic encryption circuit 44 performs one time of scramble encryption on the fingerprint datum 3 to generate a fingerprint datum 4, as shown in step S208. Then the AES circuit 36 of the bridge integrated circuit 30 performs AES encryption on the fingerprint datum 4 to generate a fingerprint datum 5, as shown in step S200. After the AES encryption, the basic encryption circuit 42 of the bridge integrated circuit 30 performs at least one time of basic encryption on the fingerprint datum 5. In the embodiment of FIG. 16, the basic encryption circuit 42 performs one time of scramble encryption on the fingerprint datum 5 to generate fingerprint datum 6, as shown in step S210. The bridge integrated circuit 30 sends the fingerprint datum 6 to the host 16 via the interface 24. The host 16 receives the fingerprint datum 6 and performs scramble decryption on it, as shown in step S310. The decryption of step S310 is against the scramble encryption of step 210. After the decryption of step S310, a fingerprint datum 5 is obtained. Then the host 16 performing AES decryption of step S300 on the fingerprint datum 5 to obtain fingerprint datum 4. At last, the host 16 performs scramble decryption on the fingerprint datum 4 to generate fingerprint datum 3 for fingerprint comparison, as shown in step S312. The decryption of step S312 is against the scramble encryption of step 208. Preferably, the decryption key may be stored in the chip 30 and the host 16 in advance bridge, without transmission through the interfaces 22 and 24. In other embodiments where the fingerprint sensor 10 and the bridge integrated circuit 30 are integrated in an SIP, the encryption circuit 18 of the fingerprint sensor 10 and the decryption circuit 38 of the bridge integrated circuit 30 can be omitted. In this case, steps S100, S102 and S204 can be omitted from FIG. 16. In other embodiments, steps S100, S102, S208 and S210 of FIG. 16 may be ways of basic encryption other than scramble encryption, and steps S100, S102, S208 and S210 may use the same way of basic encryption, or use respective ways of basic encryption. In the embodiment of FIG. 15 and FIG. 16, steps S208 and S210 are performed by two basic encryption circuits 44 and 42. However, in other embodiments, steps S208 and S210 may be performed using the same basic encryption circuit.

In the foregoing embodiment, the bridge integrated circuit 30 and the host 16 are separate. However, the circuit of the bridge integrated circuit 30 may be integrated in the host 16 if desired.

What is claimed is:

1. A bridge integrated circuit for using between a fingerprint sensor and a host, characterized in that the bridge integrated circuit comprises an encryption standard circuit configured for encrypting a first fingerprint datum with an encryption standard to obtain a second fingerprint datum.

2. The bridge integrated circuit of claim 1, wherein the encryption standard comprises Advanced Encryption Standard.

3. The bridge integrated circuit of claim 1, further comprising a decryption circuit connected to the encryption standard circuit and configured for performing partial or full decryption on a third fingerprint datum output by the fingerprint sensor to obtain the first fingerprint datum.

4. The bridge integrated circuit of claim 1, further comprising:
a decryption circuit configured for performing full decryption on a third fingerprint datum output by the fingerprint sensor to obtain a fourth fingerprint datum; and
an image signal processor connected to the decryption circuit and the encryption standard circuit, and configured for performing image processing on the fourth fingerprint datum to generate the first fingerprint datum.

5. The bridge integrated circuit of claim 4, further comprising a basic encryption circuit connected to the encryption standard circuit and configured for performing basic encryption on the second fingerprint datum.

6. The bridge integrated circuit of claim 5, wherein the basic encryption comprises scramble encryption.

7. The bridge integrated circuit of claim 1, further comprising:
a decryption circuit configured for performing full decryption on a third fingerprint datum output by the fingerprint sensor to obtain a fourth fingerprint datum;
an image signal processor connected to the decryption circuit and configured for performing image processing on the fourth fingerprint datum to generate a fifth fingerprint datum; and
a first basic encryption circuit connected to the image signal processor and the encryption standard circuit, and configured for performing basic encryption on the fifth fingerprint datum to obtain the first fingerprint datum.

8. The bridge integrated circuit of claim 7, further comprising a second basic encryption circuit connected to the encryption standard circuit and configured for performing basic encryption on the second fingerprint datum.

9. The bridge integrated circuit of claim 8, wherein the basic encryption comprises scramble encryption.

10. The bridge integrated circuit of claim 7, wherein the basic encryption comprises scramble encryption.

11. A fingerprint-encrypting method for using between a fingerprint sensor and a host, characterized in that the fingerprint-encrypting method uses an encryption standard circuit to perform a step of encrypting a first fingerprint datum with an encryption standard to obtain a second fingerprint datum.

12. The fingerprint-encrypting method of claim 11, wherein the step of encrypting a first fingerprint datum with an encryption standard comprises encrypting the first fingerprint datum with Advanced Encryption Standard.

13. The fingerprint-encrypting method of claim 11, further comprising performing partial or full decryption on a third fingerprint datum output by the fingerprint sensor to obtain the first fingerprint datum.

14. The fingerprint-encrypting method of claim 11, further comprising:
performing full decryption on a third fingerprint datum output by the fingerprint sensor to obtain a fourth fingerprint datum; and
performing image processing on the fourth fingerprint datum to generate the first fingerprint datum.

15. The fingerprint-encrypting method of claim 14, further comprising performing basic encryption on the second fingerprint datum.

16. The fingerprint-encrypting method of claim 15, wherein the basic encryption comprises scramble encryption.

17. The fingerprint-encrypting method of claim 11, further comprising:
performing full decryption on a third fingerprint datum output by the fingerprint sensor to obtain a fourth fingerprint datum;
performing image processing on the fourth fingerprint datum to generate a fifth fingerprint datum; and
performing basic encryption on the fifth fingerprint datum to obtain the first fingerprint datum.

18. The fingerprint-encrypting method of claim 17, further comprising performing basic encryption on the second fingerprint datum.

19. The fingerprint-encrypting method of claim 18, wherein the basic encryption comprises scramble encryption.

20. The fingerprint-encrypting method of claim 17, wherein the basic encryption comprises scramble encryption.

21. A fingerprint-detecting-and-encrypting circuit, comprising:
a fingerprint sensor configured for detecting a fingerprint and outputting a first fingerprint datum; and
a bridge integrated circuit connected to the fingerprint sensor and configured for performing processing on the first fingerprint datum, wherein the processing comprises performing encryption with an encryption standard.

22. The fingerprint-detecting-and-encrypting circuit of claim 21, wherein the encryption standard comprises Advanced Encryption Standard.

23. The fingerprint-detecting-and-encrypting circuit of claim 21, wherein the bridge integrated circuit comprises an encryption standard circuit connected to the fingerprint sensor and configured for encrypting the first fingerprint datum with the encryption standard to generate a second fingerprint datum.

24. The fingerprint-detecting-and-encrypting circuit of claim 23, wherein the fingerprint sensor comprises:
a sensing unit configured for detecting the fingerprint to generate a third fingerprint datum; and
a basic encryption circuit connected to the sensing unit and configured for performing basic encryption on the third fingerprint datum to generate the first fingerprint datum.

25. The fingerprint-detecting-and-encrypting circuit of claim 24, wherein the basic encryption comprises scramble encryption.

26. The fingerprint-detecting-and-encrypting circuit of claim 21, wherein the fingerprint sensor comprises a sensing unit configured for detecting the fingerprint to generate the first fingerprint datum.

27. The fingerprint-detecting-and-encrypting circuit of claim 21, wherein the fingerprint sensor comprises:
a sensing unit configured for detecting the fingerprint to generate a second fingerprint datum; and
a basic encryption circuit connected to the sensing unit and configured for performing at least one time of basic encryption on the second fingerprint datum to generate the first fingerprint datum.

28. The fingerprint-detecting-and-encrypting circuit of claim 27, wherein the bridge integrated circuit comprises:
a decryption circuit connected to the fingerprint sensor and configured for performing partial or full decryption on the first fingerprint datum that has received two or more than two times of basic encryption to generate a third fingerprint datum; and
an encryption standard circuit connected to the decryption circuit and configured for encrypting the third fingerprint datum with the encryption standard to generate a fourth fingerprint datum.

29. The fingerprint-detecting-and-encrypting circuit of claim 27, wherein the bridge integrated circuit comprises:
a decryption circuit connected to the fingerprint sensor and configured for fully decrypting the first fingerprint datum to generate a third fingerprint datum;
an image signal processor connected to the decryption circuit and configured for performing image processing on the third fingerprint datum to generate a fourth fingerprint datum; and
an encryption standard circuit connected to the image signal processor and configured for encrypting the fourth fingerprint datum with the encryption standard to generate a fifth fingerprint datum.

30. The fingerprint-detecting-and-encrypting circuit of claim 27, wherein the bridge integrated circuit comprises:
a decryption circuit connected to the fingerprint sensor and configured for fully decrypting the first fingerprint datum to generate a third fingerprint datum;
an image signal processor connected to the decryption circuit and configured for performing image processing on the third fingerprint datum to generate a fourth fingerprint datum;
an encryption standard circuit connected to the image signal processor and configured for encrypting the fourth fingerprint datum with the encryption standard to generate a fifth fingerprint datum; and
a second basic encryption circuit connected to the encryption standard circuit and configured for performing basic encryption on the fifth fingerprint datum to generate a sixth fingerprint datum.

31. The fingerprint-detecting-and-encrypting circuit of claim 30, wherein the basic encryption comprises scramble encryption.

32. The fingerprint-detecting-and-encrypting circuit of claim 27, wherein the bridge integrated circuit comprises:
a decryption circuit connected to the fingerprint sensor and configured for fully decrypting the first fingerprint datum to generate a third fingerprint datum;
an image signal processor connected to the decryption circuit and configured for performing image processing on the third fingerprint datum to generate a fourth fingerprint datum;
a second basic encryption circuit connected to the image signal processor and configured for performing basic encryption on the fourth fingerprint datum to generate a fifth fingerprint datum; and
an encryption standard circuit connected to the second basic encryption circuit and configured for encrypting the fifth fingerprint datum with the encryption standard to generate a sixth fingerprint datum.

33. The fingerprint-detecting-and-encrypting circuit of claim 32, wherein the bridge integrated circuit further comprises a third basic encryption circuit connected to the encryption standard circuit and configured for performing basic encryption on the sixth fingerprint datum to generate a seventh fingerprint datum.

34. The fingerprint-detecting-and-encrypting circuit of claim 33, wherein the basic encryption comprises scramble encryption.

35. The fingerprint-detecting-and-encrypting circuit of claim 32, wherein the basic encryption comprises scramble encryption.

36. The fingerprint-detecting-and-encrypting circuit of claim 27, wherein the basic encryption comprises scramble encryption.

37. A fingerprint-detecting-and-encrypting method, comprising steps of:
detecting a fingerprint and generating a first fingerprint datum accordingly; and
performing processing on the first fingerprint datum through a bridge integrated circuit, wherein the processing comprises performing encryption with an encryption standard.

38. The fingerprint-detecting-and-encrypting method of claim 37, wherein the step of performing encryption with an encryption standard comprises performing encryption with Advanced Encryption Standard.

39. The fingerprint-detecting-and-encrypting method of claim 37, wherein the step of performing processing on the first fingerprint datum comprises using an encryption standard circuit to encrypt the first fingerprint datum with the encryption standard to generate a second fingerprint datum.

40. The fingerprint-detecting-and-encrypting method of claim 39, wherein the step of detecting the fingerprint and generating the first fingerprint datum accordingly comprises:
detecting the fingerprint to generate a third fingerprint datum; and
performing basic encryption on the third fingerprint datum to generate the first fingerprint datum.

41. The fingerprint-detecting-and-encrypting method of claim 40, wherein the basic encryption comprises scramble encryption.

42. The fingerprint-detecting-and-encrypting method of claim 37, wherein the step of detecting the fingerprint and generating the first fingerprint datum accordingly comprises:
detecting the fingerprint to generate a second fingerprint datum; and
performing at least one time of basic encryption on the second fingerprint datum to generate the first fingerprint datum.

43. The fingerprint-detecting-and-encrypting method of claim 42, wherein the step of performing processing on the first fingerprint datum comprises:
performing partial or full decryption on the first fingerprint datum that has received more than two times of basic encryption to generate third fingerprint datum; and
using an encryption standard circuit to encrypt the third fingerprint datum with the encryption standard to generate a fourth fingerprint datum.

44. The fingerprint-detecting-and-encrypting method of claim 42, wherein the step of performing processing on the first fingerprint datum comprises:
fully decrypting the first fingerprint datum to generate a third fingerprint datum;
performing image processing on the third fingerprint datum to generate a fourth fingerprint datum; and
using an encryption standard circuit to encrypt the fourth fingerprint datum with the encryption standard to generate a fifth fingerprint datum.

45. The fingerprint-detecting-and-encrypting method of claim 42, wherein the step of performing processing on the first fingerprint datum comprises:
fully decrypting the first fingerprint datum to generate a third fingerprint datum;
performing image processing on the third fingerprint datum to generate a fourth fingerprint datum;
using an encryption standard circuit to encrypt the fourth fingerprint datum with the encryption standard to generate a fifth fingerprint datum; and
performing basic encryption on the fifth fingerprint datum to generate a sixth fingerprint datum.

46. The fingerprint-detecting-and-encrypting method of claim 45, wherein the basic encryption comprises scramble encryption.

47. The fingerprint-detecting-and-encrypting method of claim 42, wherein the step of performing processing on the first fingerprint datum comprises:
fully decrypting the first fingerprint datum to generate a third fingerprint datum;
performing image processing on the third fingerprint datum to generate a fourth fingerprint datum;
performing basic encryption on the fourth fingerprint datum to generate a fifth fingerprint datum; and
using an encryption standard circuit to encrypt the fifth fingerprint datum with the encryption standard to generate a sixth fingerprint datum.

48. The fingerprint-detecting-and-encrypting method of claim 47, wherein the step of performing processing on the first fingerprint datum further comprises performing basic encryption on the sixth fingerprint datum to generate a seventh fingerprint datum.

49. The fingerprint-detecting-and-encrypting method of claim 48, wherein the basic encryption comprises scramble encryption.

50. The fingerprint-detecting-and-encrypting method of claim 47, wherein the basic encryption comprises scramble encryption.

51. The fingerprint-detecting-and-encrypting method of claim 42, wherein the basic encryption comprises scramble encryption.
